(19) United States
(12) Patent Application Publication
(10) Pub. No.: US 2025/0338147 A1
(43) Pub. Date: Oct. 30, 2025

(54) ARTIFICIAL INTELLIGENCE (AI)-BASED MEDIA ACCESS CONTROL (MAC) LAYER OPTIMIZATION

(71) Applicant: Cisco Technology, Inc., San Jose, CA (US)

(72) Inventors: Peiman AMINI, Fremont, CA (US); Sudhir K. JAIN, Fremont, CA (US); Ardalan ALIZADEH, Campbell, CA (US); Jerome HENRY, Pittsboro, NC (US); Bahador AMIRI, Saratoga, CA (US)

(21) Appl. No.: 19/065,920

(22) Filed: Feb. 27, 2025

Related U.S. Application Data
(60) Provisional application No. 63/639,343, filed on Apr. 26, 2024.

(51) Int. Cl. H04W 24/02; G06N 3/084; H04L 5/00

(52) U.S. Cl. CPC H04W 24/02; G06N 3/084; H04L 5/0007

(57) ABSTRACT

The present disclosure provides techniques for dynamic resource management and link adaptation in wireless communication systems. An access point (AP) trains a machine learning (ML) model using a historical dataset. The AP collects real-time input data that indicate characteristics of a link established between the AP and a station (STA) for wireless communication. The AP applies the ML model to the real-time input data to predict one or more network demand values for the link. Based on the one or more predicted network demand values and the real-time input data, the AP determines one or more adjustments to transmission settings of the link. The AP applies the one or more adjustments to the wireless communication with the STA.

### CROSS-REFERENCE TO RELATED APPLICATIONS

This application claims benefit of co-pending U.S. provisional patent application Ser. No. 63/639,343 filed Apr. 26, 2024. The aforementioned related patent application is herein incorporated by reference in its entirety.

### TECHNICAL FIELD

Embodiments presented in this disclosure generally relate to wireless communication. More specifically, embodiments disclosed herein relates to utilizing artificial intelligence (AI)-driven models for dynamic resource allocation and link adaptation in wireless networks.

### BACKGROUND

In dense Wi-Fi networks, managing the trade-off between high throughput and low latency is a challenge. Transmissions modes like multiple-user multiple-input multiple-output (MU-MIMO) and orthogonal frequency-division multiple access (OFDMA) are commonly used to address this issue, but each mode has its own limitations. While MU-MIMO can increase overall throughput by serving multiple users concurrently, it may introduce delays due to data aggregation requirements. Conversely, OFDMA minimizes delay but does not fully maximize throughput under high user loads. Additionally, conventional link adaptation techniques, such as adjusting the modulation and coding scheme (MCS) level or configuring the aggregated medium access control protocol data unit (A-MPDU) length, rely on heuristic methods. These approaches adjust the link parameters incrementally based on observed network performance, but lack the flexibility to adapt to dynamic and rapidly changing network conditions. This rigidity can lead to suboptimal performance, particularly in fluctuating network scenarios.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A depicts an example of MU-MIMO operation, according to some embodiments of the present disclosure.

FIG. 1B depicts an example of OFDMA operation between an AP and three connected devices, according to some embodiments of the present disclosure.

FIG. 2 depicts an example workflow for predictive scheduling using a DNN-based model, according to some embodiments of the present disclosure.

FIG. 3 depicts an example workflow for adaptive resource management using reinforcement learning, according to some embodiments of the present disclosure.

FIG. 4 depicts an example workflow for AI-driven rate adaptation, according to some embodiments of the present disclosure.

FIG. 5 depicts an example workflow for collaborative optimization between an AP and its connected STAs, according to some embodiments of the present disclosure.

FIGS. 6A and 6B depict example methods for DNN-based model training and real-time inference for predictive scheduling, according to some embodiments of the present disclosure.

FIG. 7 depicts an example method for adaptive resource management using reinforcement learning, according to some embodiments of the present disclosure.

FIGS. 8A and 8B depict example methods for AI-driven link adaptation, including model training, real-time inference for goodput prediction, and determination of link configuration parameters, according to some embodiments of the present disclosure.

FIG. 9 is a flow diagram depicting an example method for AI-driven link adaptation, according to some embodiments of the present disclosure.

FIG. 10 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including training, by an access point (AP), a machine learning (ML) model using a historical dataset, the historical dataset comprising one or more link performance parameters as historical input data and one or more measured network demand values for links as target output data, collecting, by the AP, real-time input data that indicate characteristics of a link established between the AP and a station (STA) for wireless communication. applying, by the AP, the ML model to the real-time input data to predict one or more network demand values for the link between the AP and the STA, determining, by the AP, one or more adjustments to transmission settings of the link based on the one or more predicted network demand values and the real-time input data, and applying, by the AP, the one or more adjustments to the wireless communication with the STA.

Other embodiments in this disclosure provide a system of a network device comprising one or more memories collectively containing one or more programs, one or more computer processors, where the one or more processors are configured to, individually or collectively, perform an operation in accordance with one or more of the above methods.

### Example Embodiments

In Wi-Fi environments, efficiently managing the balance between high throughput and low latency presents a challenge. Two primary transmission modes, MU-MIMO and OFDMA, offer distinct advantages but also introduce trade-offs.

MU-MIMO can significantly improve throughput by enabling the simultaneous transmission of data to multiple users. However, MU-MIMO often incurs additional delays because it requires the aggregation of user data, which may not always be immediately available. Conversely, OFDMA can minimize delays by quickly transmitting smaller data packets to the receiving devices, but it fails to maximize throughput efficiency when handling a large number of users. Determining the optimal mode-whether to utilize MU-MIMO or OFDMA-based on real-time network conditions is important for maintaining a balance between speed and response time.

In addition to mode selection, conventional link adaptation strategies in APs, such as adjusting the MCS level or configuring the aggregated medium access control protocol data unit (A-MPDU) length, often rely on heuristic (or iterative) methods. These methods typically involve transmitting data using conservative initial settings (e.g., MCS 0), measuring performance metrics like goodput or packet error rate, and gradually adjusting the parameters (e.g., increasing from MCS 0 to MCS 1). While this approach has been widely adopted, it lacks the flexibility to respond effectively to the highly dynamic nature of network conditions. The reliance on predefined thresholds and iterative testing leads to suboptimal performance, particularly in environments with rapidly fluctuating link quality or user demands.

To address these challenges and other relevant concerns, the present disclosure introduces methods, systems, and apparatuses for optimizing wireless communication using AI-driven models. The disclosed embodiments focus on dynamic resource allocation and link adaptation to improve network performance and user experience in dynamic and evolving environments. By using machine learning (ML) and reinforcement learning (RL) techniques, the disclosed embodiments enable real-time analysis of network conditions to make dynamic network-wide or device-specific adjustments. In some embodiments, these dynamic adjustments may include, but are not limited to, determining the appropriate transmission mode between MU-MIMO and OFDMA, optimizing the timing for mode switching, dynamically allocating and managing resources (e.g., resource units (RUs) or spatial streams (SSs)), and efficiently adapting link parameters (e.g., MCS level, A-MPDU length).

In one embodiment, the disclosed system incorporates a deep neural network (DNN)-based model with long short-term memory (LSTM) layers to predict network demand changes across a future time interval. The DNN-based model is trained on sequential data with temporal dependencies, allowing it to learn traffic patterns and network behaviors in diverse network environments. When deployed in real-time operation, the model analyzes input metrics reflecting current network conditions and uses this information to predict future demand changes. This predictive capability allows the system to proactively adjust network configurations, such as switching between MU-MIMO and OFDMA, reconfiguring user groupings in MU-MIMO, or assigning resources like RUs or SSs to certain high-demand devices.

In one embodiment, a reinforcement learning (RL) framework is used to optimize resource allocation dynamically. The RL model (e.g., Q-learning or Deep Q-Network (DQN) algorithm) operates by defining a state space that reflects network conditions (including parameters like received signal strength indicator (RSSI), signal-to-noise ratio (SNR), and channel utilization), an action for potential resource allocation or mode switching (e.g., allocating RUs or SSs to certain devices, adjusting user grouping), and a reward function that guides the learning process to maximize (or at least increase) network performance (e.g., increasing throughput or reducing latency). Through iterative interactions with the network, the RL framework learns optimal policies for dynamically allocating resources and managing network conditions. When real-time input data about network conditions is received, the RL model determines the optimal action to be taken based on the updated policies.

In one embodiment, the disclosed system integrates a machine learning model (e.g., such as Gradient Boosting Machines (GBM) or deep neural networks (DNNs) to adjust link configurations. This model considers input features like RSSI, SNR, number of spatial streams (NSS), and channel utilization to predict goodput. Based on the predicted goodput, the disclosed system selects the appropriate link parameters, such as MCS level and A-MPDU length, to maximize (or at least improve) throughput while maintaining link stability. Unlike conventional heuristic approaches, which rely on measuring real-time link performance and incrementally increasing transmission parameters (e.g., MCS level) from low to high in a trial-and-error manner, the disclosed AI-driven approach enables adjustment of these link parameters more efficiently in response to rapidly changing network conditions.

In some embodiments, collaborative communication may be implemented between the AP(s) and STA(s) to exchange real-time performance metrics, and therefore improve the network's responsiveness to individual needs. In this configuration, the STA(s) and the AP(s) may exchange link performance parameters using a lightweight communication protocol. In some embodiments, the client device may be configured with a lightweight reasoning system that analyzes the device's current state, application requirements, and/or the received metrics from the AP, to determine an optimal (at least improved) connection configuration. The client device may send its recommendations, along with the reported performance metrics, to the AP. Upon receiving these inputs, the AP may evaluate the STA's recommendations and metrics in the context of the network's overall performance goals. The AP may balance the network-wide goals against the individual client device's preferences, and determine a link configuration that improves (or at least maintains) the experience for all users while maintaining network efficiency and fairness.

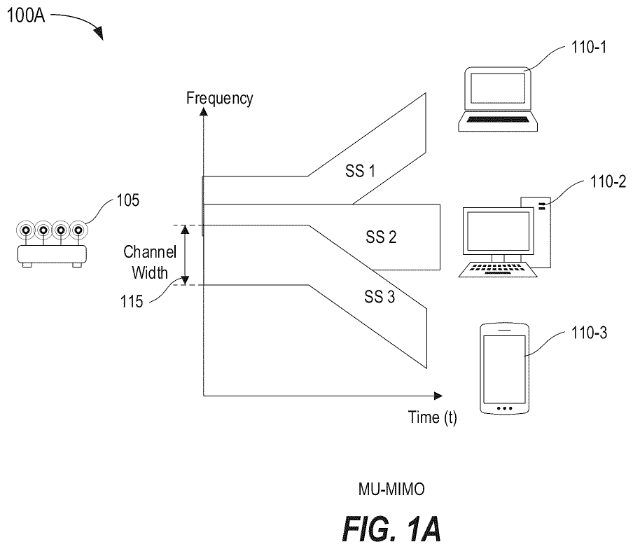

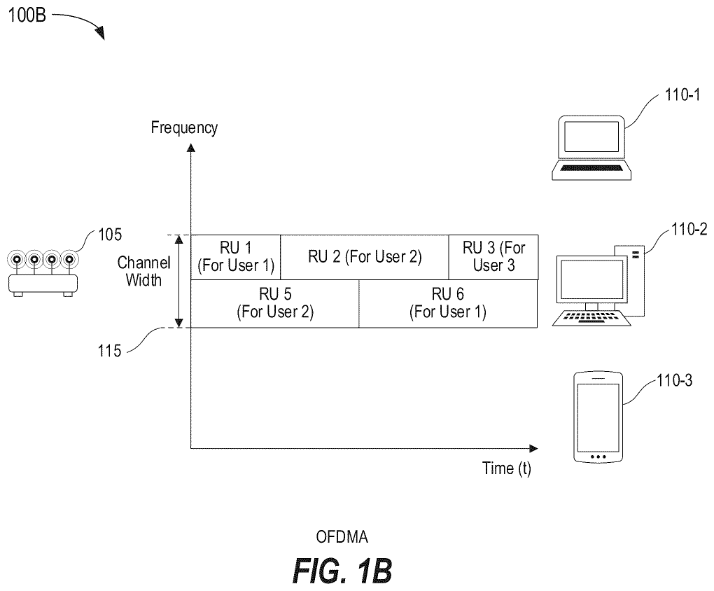

FIG. 1A depicts an example of MU-MIMO operation 100A, according to some embodiments of the present disclosure.

As depicted, the wireless communication network includes an AP 105 and three client devices (also referred to in some embodiments as stations (STAs)) 110-1, 110-2, and 110-3. The three client devices 110 are located in different spatial directions relative to the AP 105, which allows the implementation of multiple spatial streams (SSs) through beamforming. In embodiments where two devices are in close proximity and their spatial separation is insufficient for distinct beamforming, the two devices may be grouped into a single user group, and a shared spatial stream may be used to serve both devices.

In the MU-MIMO mode, as depicted, the AP 105 creates three spatial streams (SSs), with each stream serving a respective client device 110 concurrently. As illustrated in this figure, SS1 is serving the client device 110-1, SS2 is serving the client device 110-2, and SS3 is serving the client device 110-3. Each spatial stream occupies the entire channel bandwidth 115. The channel bandwidth may vary depending on network configuration, ranging from 20 MHZ (e.g., supported in 2.4 GHz band) to wider bandwidth like 40 MHz, 80 MHZ, or 160 MHz (e.g., supported in 5 GHz or 6 GHz band). The MU-MIMO mode effectively utilizes the channel's spatial dimensions to serve multiple devices at the same time and therefore achieves high throughput in wireless communication. However, MU-MIMO may introduce delays because it requires the aggregation of user data before transmission, which can be affected by data availability and processing time. These delays constitute a trade-off for the high throughput benefits of MU-MIMO. Given the benefits and limitations, MU-MIMO is preferred for applications that prioritize throughput over latency, such as high-definition video streaming, large file downloads, and other bandwidth-intensive activities. When the STAs 110 are running these applications, exhibiting high and concurrent data demands that require significant throughput, the AP 105 may consider switching from other modes (e.g., OFDMA) to MU-MIMO. The mode switching and its optimal timing may be determined by a trained ML model that monitors real-time network/link conditions, application requirements, and device-specific capabilities.

In some embodiments, the ML model may include DNNs coupled with LSTM layers. The model may be trained on a historical dataset that includes sequential timestamps of network metrics (also referred to in some embodiments as link performance parameters or metrics) (e.g., throughput, latency, RSSI, SNR, channel utilization). By learning temporal traffic patterns and device behaviors, the model predicts future network demand and proactively schedules mode switching to ensure optimal resource allocation and performance.

In some embodiments, RL may be used to dynamically learn mode switching or resource allocation policies based on observed network states and feedback in the form of positive or negative rewards (e.g., developed based on metrics like throughput, latency, and user satisfaction score).

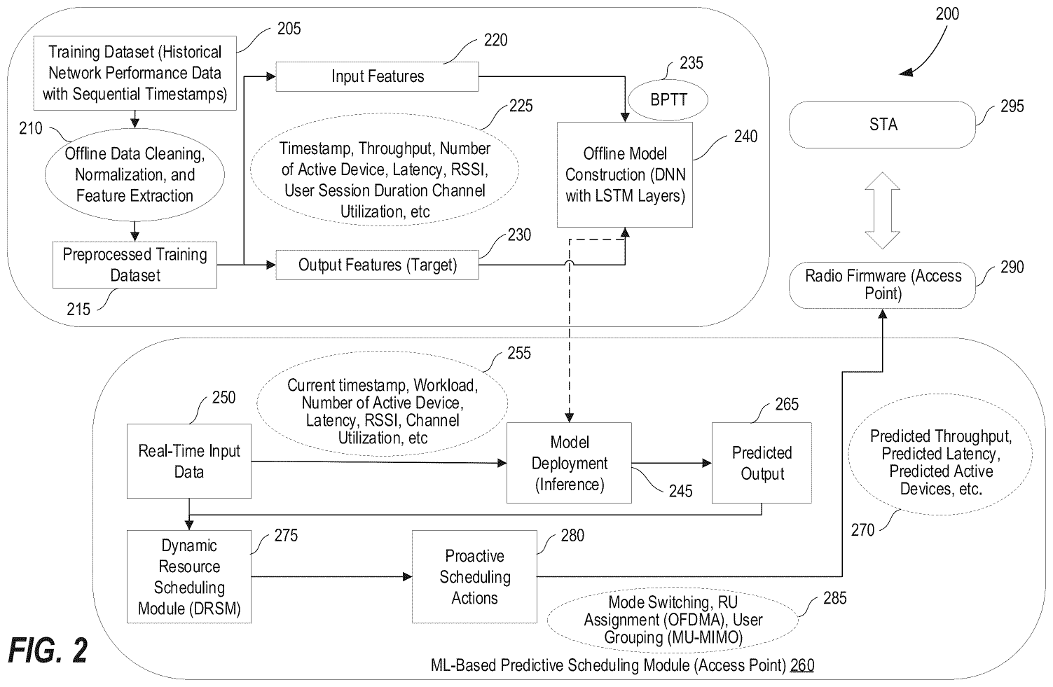

In some embodiments, the ML model may use algorithms like Gradient Boosting Machines (GBM) or DNNs and be trained to predict goodput (and/or packet error rate) under detected network conditions. The AP may then use the predicted goodput (and/or packet error rate), along with real-time metrics (e.g., bandwidth, RSSI, NSS), to determine the optimal link configuration, including MCS level or A-MPDU length. Further technical details about these ML-based models, predictive scheduling, and adaptive link management are discussed below with references to FIGS. 2-5.

FIG. 1B depicts an example of OFDMA operation 100B between an AP and three connected devices, according to some embodiments of the present disclosure.

As depicted, the AP 105 is connected to three STAs 110-1, 110-2, and 110-3. In this configuration, the AP 105 operates under OFDMA mode, dividing the channel bandwidth 115 into five resource units (RUs) to serve the three client devices 110 concurrently. Specifically, as depicted, RU1 is assigned to STA 110-1, RU2 is assigned to STA 110-2, RU3 is assigned to STA 110-3, RU4 is assigned to STA-2, and RU5 is assigned to STA 110-1. The channel width may range from 20 MHz to 160 MHz. The OFDMA mode enables the AP to allocate resources flexibly based on the traffic demands of each STA, providing significant benefits for applications that require low latency and frequent small packet transmissions. These applications include, but are not limited to, voice over IP (VOIP), real-time gaming, and Internet of Things (IoT) communications. However, the OFDMA mode has limitations in scenarios requiring high throughput, as dividing the channel into smaller RUs reduces the bandwidth available for individual transmissions. As a result, OFDMA is less preferred for bandwidth-intensive applications like high-definition video streaming or large file transfers.

The AP 105 may switch to OFDMA mode when the network conditions include multiple devices with low data demands or latency-sensitive applications that benefit from parallel transmissions. As discussed in FIG. 1A, the mode switching between MU-MIMO and OFDMA and corresponding resource allocation may be guided by AI-based decision-making. The AP may use trained ML models that monitor real-time network conditions and application demands to predict traffic patterns and proactively schedule mode switching. Further details on these AI-driven optimization frameworks are discussed below with references to FIGS. 2-5.

FIG. 2 depicts an example workflow 200 for predictive scheduling using a DNN-based model, according to some embodiments of the present disclosure.

As depicted, the ML model 240 is constructed using DNNs with multiple LSTM layers. The LSTM layers are well-suited to handle sequential data, particularly in capturing temporal dependencies and patterns in the data and enabling subsequent time-series forecasting. In this configuration, the DNN-based model 240 is trained to predict network traffic demand over time. Based on the predicted network demands, the system may then determine proactive scheduling actions 280 to optimize network performance and improve user experience.

As shown, before deployment 245, the DNN-based model 240 learns traffic patterns from the training dataset 205. In some embodiments, the training dataset 205 may include the performance data of a network collected over a certain period. The training dataset may be sequential in nature, with each data point timestamped to reflect the temporal progression of network conditions. For example, the performance data of a university campus network may reveal that traffic patterns are influenced by the academic schedule. More specifically, the performance data may show that network demand spikes during class breaks and lunch hours and drops significantly during class hours when fewer devices are actively transmitting data. These recurring patterns are embedded in the sequential datasets, allowing the ML model, with LSTM layers, to capture these temporal dependencies and predict future traffic demand with high accuracy.

In some embodiments, the training dataset 205 may include various metrics that reflect network load and service quality, including, but not limited to, the number of active devices, throughput (Mbps), latency (ms), RSSI (dBm), user session durations (seconds), channel utilization, and device activity levels. These metrics may then be extracted from the raw data as input features for model training.

As shown, the model training process begins with data preprocessing 210, where raw historical data is cleaned, normalized, and transformed into a preprocessed training dataset 215 (which is ready for input into the ML model). In some embodiments, the preprocessing may involve three stages: cleaning, normalization, and feature extraction. In the cleaning stage, missing or inconsistent values in the dataset are identified and properly addressed. For example, missing throughput or latency values may be filled using interpolation (e.g., estimating the missing values by using the surrounding known values) or mean imputation techniques (e.g., replacing the missing values with the mean of the available data), and outliners and/or anomalies (e.g., unusually high latency spikes) may be removed through filtering or smoothing. Next, normalization is applied to standardize the data. Metrics like throughput, latency, RSSI, and user session durations, are transformed to a consistent scale or unit for analysis. Feature extraction is then performed to identify and extract input features 220 from the raw data.

As depicted, the preprocessed training dataset 215 includes input features 220 and target output features 230. The input features 220 may include a variety of metrics (as depicted by block 225) that reflect network load and/or quality of service (QOS), such as throughput (Mbps), the number of active devices, latency (ms), RSSI (dBm), user session duration (seconds), and channel utilization, among others. Beyond that, the input features may further include metrics that capture trends or temporal context, such as timestamps (e.g., 2:00 PM) or time-of-day indicators (e.g., lunch hour, morning class).

The target output 230 for training may include specific metrics that represent network demand and conditions, as measured by human editors or automated systems during subsequent time intervals. These measured metrics serve as the ground truth, providing the necessary reference data for the model to learn in a supervised learning framework. In some embodiments, the target output may include metrics such as the number of active devices, throughput (Mbps), latency (ms), RSSI (dBm), user session duration (seconds), and others.

The training process is designed to minimize the error between the predicted output and the actual measured values in the target output using a supervised learning framework. The model, constructed as a DNN-based model with multiple LSTM layers, is well-suited for capturing temporal dependencies in sequential data. As depicted, the training process involves feeding the model with historical network performance data 220, including metrics such as current throughput, latency, RSSI, and channel utilization, along with their corresponding target output 230 during subsequent time intervals. In some embodiments, back propagation through time (BPTT) techniques 235 may be used to train the model 240. In this process, the model processes a sequence of input data points over a time window to generate predicted outputs for each time step. The loss is calculated for the entire sequence by comparing the predicted values with the actual target metrics at each time step using a regression loss function (e.g., mean squared error). The calculated error is then backpropagated backwards through the network layers, where gradients for each parameter (e.g., weights or biases) in the model are computed, including the temporal connections in the LSTM layers. Following that, the gradients are used to iteratively update the parameters (e.g., weights or biases) of layers via optimization algorithms (e.g., stochastic gradient descent (SGD)), enabling the model to learn both short-term and long-term dependencies. Over multiple training epochs (or iterations), the model gradually reduces the prediction errors by iteratively adjusting its internal parameters. As the training process progresses, the model learns to accurately capture the relationships between input features 220 and target outputs 230, making it ready for deployment to forecast future network demand based on real-time input data 250.

In some embodiments, a validation dataset may be used during the training process to monitor the model's performance and avoid overfitting. In some embodiments, a testing dataset, separate from both the training and validation datasets, may be used to independently evaluate the model's accuracy and reliability before deployment.

As depicted, once the training is complete, the model 240 is deployed on the AP as part of the ML-based predictive scheduling module 260. During inference 245, the model processes real-time input data 250 to predict network conditions and support dynamic resource management. The real-time input data 250 may include metrics that represent the current state of the network, such as current throughput demand (Mbps), latency (ms), channel utilization, the number of currently active devices, and others (as depicted by block 255). Additionally, the real-time input data 250 further includes metrics that provide temporal context, such as timestamps or time-of-day indicators (e.g., lunch break, morning class). These temporal metrics enable the model to account for recurring patterns and trends in network behavior that are influenced by time. The trained model processes these real-time inputs 250 to generate predicted outputs 265. In some embodiments, the predicted outputs 265 may include metrics that provide insights into future network conditions and demand (e.g., the next time interval). These predictions may include the predicted throughput (Mbps), the estimated number of active devices, the predicted latency (ms), and others.

As depicted, the predicted outputs 265, along with the real-time input data 250, are provided to the dynamic resource scheduling module (DRSM) 275 for further analysis. As discussed above, the real-time input data reflects the current network state and demand, including metrics such as current throughput, latency, and channel utilization, and the number of currently active devices. In contrast, the predicted output data 265 indicates the expected network conditions and demand for one or more subsequent time intervals, including metrics such as predicted throughput, latency, and channel utilization, and the estimated number of active devices. By comparing the predicted outputs 265 against the real-time input data 250, the DRSM 275 determines the trend in network conditions. For example, an increasing trend may be identified when the predicted throughput is significantly higher than the current values, a stable trend may be identified when the predicted metrics are approximately equal to the current metrics, and a decreasing trend may be determined when the predicted throughput is lower than the current values. In addition to identifying trends, the DRSM 275 may further classify the overall demand level (e.g., high, medium, or low) based on predefined thresholds for the predicted metrics. Based on the identified demand level and trend, the DRSM 275 determines proactive scheduling actions 280 to optimize network performance. These actions (as depicted by block 285) may include mode switching, such as between MU-MIMO operation (as depicted in FIG. 1A) and OFDMA operation (as depicted in FIG. 1B). For example, if the demand is classified as high with increasing throughput, the DRSM 275 may instruct the AP to switch from OFDMA to MU-MIMO to serve high-throughput devices concurrently. Conversely, if the demand is low or the number of active devices is high but throughput demand is decreasing, OFDMA may be maintained to prioritize latency-sensitive applications. The proactive scheduling actions 280 may further include resource allocation adjustments (as depicted by block 285). For example, when OFDMA is selected, RUs may be allocated in advance to match device-specific throughput and latency requirements. If MU-MIMO is determined to be the optimal mode, user groupings may be reconfigured proactively to optimize the use of spatial streams.

In the context of a university campus network, the trained ML model 240 may learn from historical data to recognize patterns such as increased activity during class breaks or lunch hours and make accurate predictions of upcoming network demand. For example, during class breaks, predicted throughput and channel utilization may indicate high demand with an increasing trend due to a surge in student activities, such as streaming videos or downloading lecture materials. In response, the DRSM 275 may switch to MU-MIMO to maximize (at least improve) throughput and allocate spatial streams to high-demand devices. In contrast, during class hours, when predicted throughput is low and the trend is stable, the DRSM 275 may switch back to OFDMA and optimize RU assignments to prioritize low-latency communications for IoT devices.

As depicted, the determined proactive actions 280 are then executed by the AP through the radio firmware 290. In some embodiments, the radio firmware 290 may translate the high-level decisions into specific hardware-level commands to configure the AP's radio hardware to implement the required adjustments (e.g., mode switching, resource allocation, and spatial stream configuration). For actions 280 that require coordination or input from a connected STA 295, the necessary information may be communicated to the STA 295 via management frames using a lightweight communication protocol.

Since APs typically have limited computational resources, in some embodiments, the trained ML model, during deployment, may be optimized using techniques such as model quantization or pruning for efficient inference. These techniques reduce computational demand without causing significant loss of accuracy.

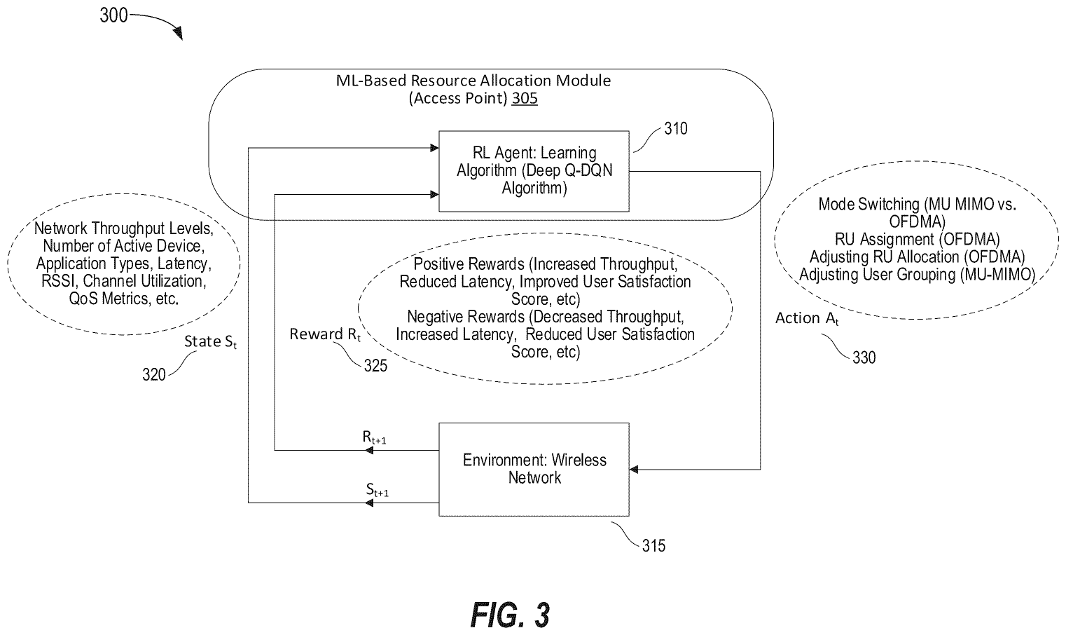

FIG. 3 depicts an example workflow 300 for adaptive resource management using reinforcement learning (RL), according to some embodiments of the present disclosure.

As depicted, a RL framework is implemented to dynamically manage resource allocation between MU-MIMO and OFDMA, optimizing the network in real time based on learned environmental responses. Similar to the embodiments disclosed in FIG. 2, the RL-based resource management framework enables an AP to adjust resource allocation and perform mode switching based on real-time network conditions to improve performance. However, compared with the temporal prediction-based embodiments described above with reference to FIG. 2, the RL-based framework may provide additional benefits in some cases. Specifically, the RL-based framework allows the AP to make more granular adjustments to resource allocation by evaluating the effectiveness of its action continuously and in real time. For example, the model can fine-tune RU assignments in OFDMA or reconfigure user groupings in MU-MIMO dynamically during operation. Additionally, unlike embodiments where model is trained offline using historical data, the RL-based framework learns while executing actions. The RL agent interacts with the network environment, explores different resource allocation strategies, and refines its policy in real time based on the rewards received.

As depicted, the RL agent 310 observes the current state (Sₜ) 320 of the environment and selects an action (Aₜ) 330 based on its current policy. After performing the action (Aₜ) 330, the environment transitions to a new state (Sₜ+1) and provides a reward (Rₜ) 325 to the RL agent 310. The reward 325 reflects the effectiveness of the action (Aₜ). Using the observed reward 325, the new state, and its learning algorithm, the RL agent 310 updates its policy to improve future decision-making accuracy (e.g., selecting actions that maximize cumulative reward).

Within the application of dynamic resource management and mode switching, as depicted, the RL agent 310 uses a Q-learning or Deep Q-Network (DQN) algorithm as its learning framework. The environment 315 in this context refers to a wireless network, including an AP (e.g., 105 of FIG. 1A) and all its connected STAs (e.g., 110 of FIG. 1A).

The state data 320 captures the current network performance, including metrics like throughput (Mbps), latency (ms), channel utilization, RSSI (dBm), the number of active devices, user session durations (seconds), types of active applications (e.g., video streaming, web browsing), and other relevant quality of service (QOS) indicators. The actions 330 represent the decisions the RL agent can make to optimize network performance. These actions may include mode switching between OFDMA and MU-MIMO, modifying the number and size of RUs assigned to devices (in OFDMA), and reconfiguring user groupings to optimize spatial stream usage (in MU-MIMO), among others.

The reward function 325 is defined to quantify the effectiveness of an action, which guides the agent to improve its decisions over time. In some embodiments, the reward (Rₜ) 325 may be determined based on network performance metrics, such as throughput (or goodput), latency, and user satisfaction scores. In this configuration, a positive reward (e.g., “+10”) may be defined when an action leads to increased throughput, reduced latency, and/or improved user satisfaction score, while a negative reward (e.g., “−5”) may be defined when an action leads to decreased throughput, increased latency, and/or decreased user satisfaction score. In addition, a neutral reward (e.g., “0”) may be defined when an action neither improves nor degrades performance.

The RL agent 310 observers the current state of the network (e.g., current throughput, latency, and the number of active devices) and selects an action 330 (e.g., switching modes, adjusting RUs) from its defined action space. The selected action 330 is then applied to the network (environment 315), modifying the AP's configuration and, where necessary, the configuration of the connected STAs. The updated performance metrics (e.g., updated throughput, latency, and active devices) are detected, and the reward 325 is calculated based on the effectiveness of the action 330. Using the reward 325 and the updated state (Sₜ₊₁), the RL agent 310 refines its policy through iterative learning. For example, if the initial state reports a throughput of 4500 Mbps, a latency of 50 ms, and 80 active devices, and the selected action is to switch from OFDMA to MU-MIMO, the environment responds with updated performance metrics, indicating that the throughput increases to 5500 Mbps and the network latency is reduced to 40 ms. In this configuration, a positive reward is provided, reinforcing the RL agent's decision. The RL agent learns that switching to MU-MIMO under such conditions improves network performance and integrates this knowledge into its policy. Conversely, if the same action under different conditions results in a reduced throughput (e.g., 4000 Mbps) and an increased latency (e.g., 60 ms), a negative reward is provided. The RL agent learns that switching to MU-MIMO in this scenarios degrades performance and adjusts its policy to avoid similar decisions in the future. Through the iterative learning process, the RL agent 310 progressively improves its policy, learning to determine actions that are optimal for given real-time network conditions. The developed RL agent 310 may be implemented on the AP as part of the ML-based resource allocation module 305 to enable real-time, adaptive network optimization.

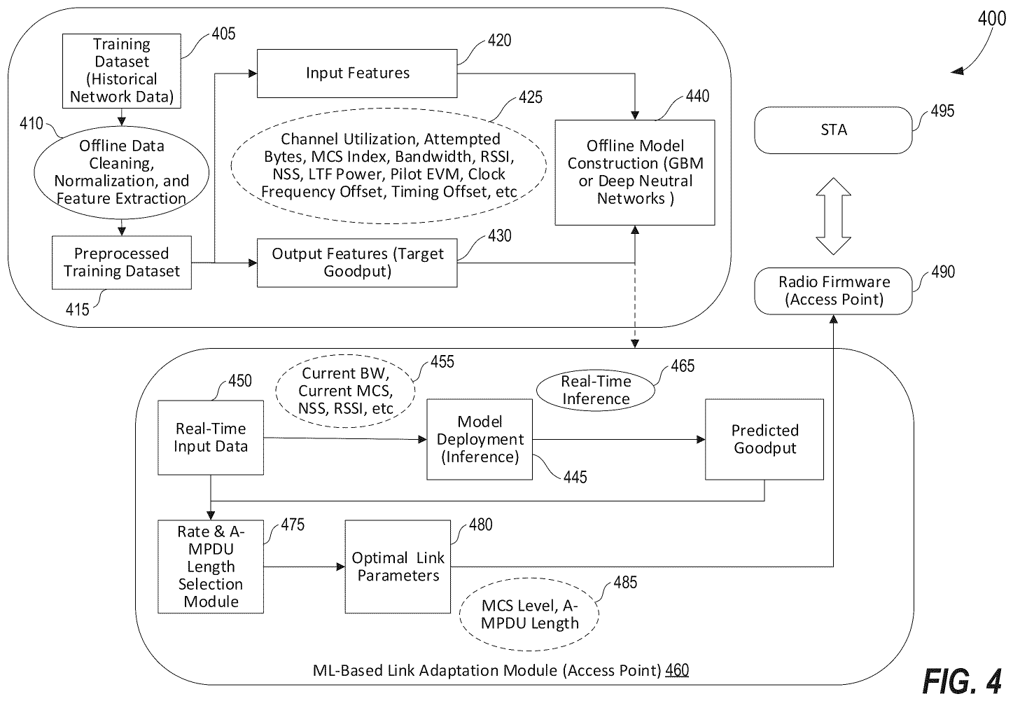

FIG. 4 depicts an example workflow 400 for AI-driven link adaptation, according to some embodiments of the present disclosure.

The workflows 200 (depicted in FIG. 2) and 300 (depicted in FIG. 3) focus on high-level resource allocation decisions, such as mode switching between OFDMA and MU-MIMO, to address network-wide demands. In some embodiments, such high-level adjustments may not be needed or preferred, particularly when the current mode (e.g., OFDMA or MU-MIMO) is already suitable for the traffic type or user distribution. In such configurations, fine-grained link adaptation, such as modifying MCS levels or A-MPDU lengths, may be used to optimize network performance. These fine-grained adjustments are less disruptive and more suitable for scenarios where traffic patterns change gradually and require incremental performance improvements.

The workflow 400 provides a method for fine-grained link adaptation by using a trained ML model 440. More specifically, the model 440 is trained to predict goodput under real-time network conditions, using input data like current bandwidth (BW), current MCS level, NSS, RSSI, and A-MPDU length, among others. With the predicted goodput 465, the AP determines the link parameters 480 (e.g., adjusted MCS level, adjusted A-MPDU length) that maximize (or at least improve) network performance. This approach ensures that with or without high-level mode switching, the network can dynamically adapt to real-time network conditions and achieve optimal (or at least improved) performance and user experience.

As used herein, goodput refers to the actual data successfully delivered to the application layer of a receiving device. The goodput excludes retransmissions, protocol overhead, and corrupted packets, and therefore reflects the effective throughput received by user devices. The use of predicted goodput 465 to determine link parameters 480 provides advantages over conventional methods, which often rely on heuristic adjustments that involve incrementally changing these parameters from low to high (e.g., starting from MCS 0) in a trail-and-error manner. Such conventional methods are time-consuming and inefficient and often result in suboptimal configurations, particularly in rapidly changing network environments. In contrast, the disclosed ML-based approach provides a data-driven determination of link parameters, leading to faster and more accurate adjustments to optimize network performance and improve user experience.

As depicted, the ML model 440 is implemented using algorithms such as gradient boosting machines (GBM) or deep neural networks (DNNs). The training dataset 405 includes performance data collected under a wide range of network conditions, which enables the model 440 to learn to predict goodput accurately across diverse scenarios. In some embodiments, the training dataset may include metrics that reflect various network parameters and conditions, including, but not limited to, MCS level used during transmission, frame aggregation length, payload size, and aggregated bitrate. In some embodiments, the training dataset 405 may also account for the number of connected devices to an AP, the distance between the AP and each connected device, and the impact of background traffic from competing data streams.

As depicted, to prepare the data for training, offline preprocessing 410 is performed to generate a high-quality, preprocessed dataset 415. In some embodiments, the preprocessing may include three stages: cleaning, normalization, and feature extraction and selection. The raw data within the training dataset 405 may first be cleaned to address missing values and remove corrupted data points. Normalization may then be applied to standardize the scale of continuous variables, preventing large ranges from dominating the training process. Following that, feature extraction may be conducted to isolate relevant inputs and outputs for model training. As shown, the input features 420 may include metrics such as channel utilization, transmitted bytes, and optionally, parameters like channel bandwidth (BW), RSSI, the MCS index, the NSS, LTF power, Pilot EVM, clock frequency offset, and timing offset (as depicted by block 425). In some embodiments, computed metrics that capture trends or temporal variations in network conditions may also be included as additional input features, such as average of RSSI or SNR over recent intervals or moving average of MCS changes over time. The output feature 430 may include the measured goodput, which reflects the effective throughput achieved under the various network conditions.

Once the preprocessed training dataset 415 is ready, the model 440 is trained to learn the relationship between the input features 420 and the target goodput 430. During each training epoch (or iteration), the model 440 processes the input features 420 to predict goodput and compares this prediction with the target goodput 430 from the dataset. The error between the predicted and target goodput is computed using a loss function (e.g., mean squared error (MSE). Backpropagation is then used to minimize (or at least reduce) this error. Specifically, the error is propagated backward through the model to calculate gradients for the internal parameters (e.g., weights or biases of layers within the DNNs). With the gradients, these internal parameters are updated using optimization algorithms (e.g., stochastic gradient descent (SGD)) to gradually improve the model's accuracy. The model 440 may complete multiple training iterations (also referred to in some embodiments as training epochs), during which the model refines its predictions, learning to generalize across a wide range of network scenarios.

In some embodiments, a validation dataset may be used during the training process to monitor the model's performance on unseen data and therefore avoid overfitting. As used herein, overfitting refers to a situation where a trained ML model performs well on the training data but fails to predict accurately on new unseen data. In some embodiments, before deployment, a test dataset may be used to evaluate the model's performance under realistic conditions. The testing dataset may include data different from both the training and validation datasets and provide a final assessment of the model's accuracy and reliability. The model is considered ready for deployment only when it meets predefined criteria, such as achieving acceptable levels of prediction accuracy or error metrics (e.g., mean squared error) falling below a threshold.

As depicted, the trained model 440 is deployed on the AP as part of the ML-based link adaptation module 460. During inference 445, the model analyzes real-time input data 450, such as current RSSI, channel BW, MCS level, the NSS, and other relevant metrics (as depicted by block 455), to predict goodput 465 under current network conditions. The predicted goodput 465 represents the achievable throughput—the data successfully delivered to the application layer of a receiving device—as estimated by the model based on the current network conditions. The predicted goodput 465 eliminates the need for iterative trial-and-error adjustments commonly used in conventional link adaptation methods.

As mentioned above, traditional approaches rely on the testing or experimentation to measure goodput, starting with conservative settings such as a low MCS level (e.g., MCS 0) or short A-MPDU length. The system then incrementally adjusts these parameters, testing at each step to ensure that performance is not degraded due to retransmissions or reduced reliability. While effective, this process introduces latency and inefficiency, particularly in dynamic network environments with rapidly changing conditions. In contrast, the disclosed ML-based approach bypasses the testing or experimentation during link adaptation. By using the predicted goodput 465, the system may directly determine optimal link parameters such as the MCS level and A-MPDU length without requiring trail-and-error testing. The predicted goodput 465, combined with real-time input data (reflecting the current network state), is fed into the rate and A-MPDU length selection module 475. This module 475 incorporates a reasoning system to analyze the predicted goodput 465 and network conditions, and determine the optimal configuration for the current link 480.

As used herein, the optimal link parameters 480 refer to the parameters that can maximize (or at least improve) data rate under current network conditions without degrading performance. These parameters may include the maximum (or at least increased) MCS level and the maximum (or at least increased) A-MPDU length that the network can support. As used herein, the MCS level refers to the modulation scheme and coding rate used for data transmission. Higher MCS levels utilize more complex modulation schemes (e.g., 256-QAM, 1024-QAM), which provide higher data rates but require better signal quality, such as high RSSI and SNR. However, if the chosen MCS level exceeds the limit that the current signal quality can support, it leads to excessive errors and retransmissions and therefore reduces the effective throughput (also referred to in some embodiments as the goodput) and degrades the overall performance. Therefore, the optimal MCS level is the highest level that maintains acceptable error rates under the current network conditions. As used herein, the A-MPDU length determines the size of aggregated frames sent in a single transmission. Larger A-MPDU lengths improve efficiency by reducing payload overhead, which increases throughput. However, a longer A-MPDU length also increases the risk, as retransmission large chunks of data can significantly degrade performance. The optimal A-MPDU length is the largest size the link can support without increasing retransmissions or impacting latency beyond acceptable limits.

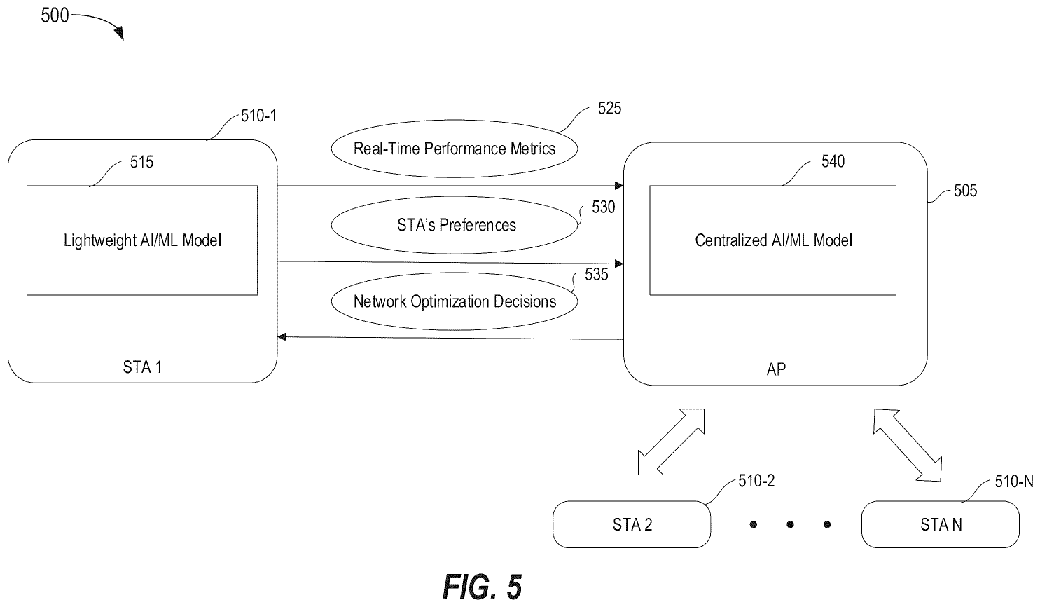

Once the optimal link parameters 480 are determined, these parameters are sent to the radio firmware 490 within the AP for implementation. The radio firmware 490 translates these parameters into hardware-level configurations to adjust the link settings in real time. If the adjustment involves changes that affect the client devices (e.g., altering MCS levels or A-MPDU settings that require STA compliance), the updated information is communicated to the STAs via management frames using a lightweight communication protocol. More details about the synchronization and collaborative optimization are discussed below with reference to FIG. 5.

FIG. 5 depicts an example workflow 500 for collaborative optimization between an AP and its connected STAs, according to some embodiments of the present disclosure.

As depicted, the collaborative optimization framework uses lightweight communication protocols to facilitate interaction between the AP 505 and its connected STAs (from 510-1 to 510-N). In this framework, the STA 510-1 is configured with a lightweight ML model or reasoning system 515, which is capable of analyzing the device's own performance data and determining the preferred link configuration based on the device's requirements. These requirements may include various objectives, such as preserving battery life, stabilizing signal quality, maximizing throughput, or minimizing latency. For example, the STA's ML model 515 may assess metrics such as throughput demands, latency sensitivity, and other QoS parameters in relation to the device's goals. If the device prioritizes battery preservation, the model may favor a mode that reduces power consumption, such as using OFDMA over MIMO. Conversely, if low latency is preferred by the device, the model may select a mode that minimize transmission delays, even if it slightly increases power usage. By evaluating these metrics and aligning them with the device's specific requirements or goals, the STA determines the optimal network mode and communicates its preferences 530, along with real-time network performance metrics (e.g., RSSI, packet error rate, or device-specific capabilities), to the AP 505.

At the AP, a centralized ML model 540 processes the data received from multiple STAs 510 and the AP's own network-wide performance metrics. This centralized model weighs the network's overall performance goals against individual STA preferences 530, finding a balance that optimizes the experience for all users. The centralized model evaluates the network state and determines optimal network optimization decisions 535. In some embodiments, these decisions 535 may include high-level adjustments, such as mode switching between OFDMA and MU-MIMO, or reassigning RUs or SSs to different devices, and/or fine-grained adjustments, such as tuning MCS levels and A-MPDU lengths for individual links. In embodiments where any of these decisions 535 require changes by the STAs to comply with new configurations (e.g., altering MCS levels or A-MPDU settings), the AP 505 may communicate these adjustments to the STAs 510. The exchange of client-reported metrics 525, preferences 530, and optimization decisions 535 may be conducted using a lightweight communication protocol. This protocol may minimize (or at least reduce) payload overhead, providing that the exchange of performance metrics and preferences does not introduce significant latency or interference with ongoing data transmissions.

The collaborative optimization framework as depicted in FIG. 5 is closely linked to the workflows as discussed above with references to FIGS. 2, 3 and 4. In the workflows 200, 300, and 400, the ML model rely on real-time input data to generate predictions. The real-time input data includes metrics that reflect network conditions, such as throughput, latency, channel unitization, RSSI, the number of active devices, the NSS, and others. Some metrics, such as channel utilization or aggregated throughput, are network-wide and can be detected internally by the AP through its monitoring systems. Other metrics, such as signal strength or application-specific requirements, are device-specific need to be reported by each STA. The collaborative optimization framework as depicted in FIG. 5 provides a mechanism for the STAs 510 to report these device-specific metrics efficiently to the connected AP 505.

Besides reporting client-specific metrics, the collaborative optimization framework further allows STAs to report their individual preferences 530 for connection configuration. This enables the AP to balance overall network performance goals with personalized optimization for individual devices.

In some embodiments, the centralized ML model 540 in the AP and/or the lightweight model 515 in the STAs may incorporate the approaches disclosed in FIGS. 2-4. For example, the centralized model 540 or the lightweight STA model 515 may incorporate a predictive scheduling framework as disclosed in FIG. 2, using historical patterns and current metrics to predict future demand and determine mode switching or resource allocation decision in advance. In some embodiments, the centralized model or lightweight STA model may adopt reinforcement learning, as discussed in FIG. 3, to make dynamic, real-time decisions, refining its strategy based on feedback from the network and STAs. In some embodiments, the centralized model or lightweight STA mode may use goodput predictions, as discussed in FIG. 4, to determine fine-grained adjustments, such as MCS levels or A-MPDU lengths, to maximize (or at least improve) link efficiency.

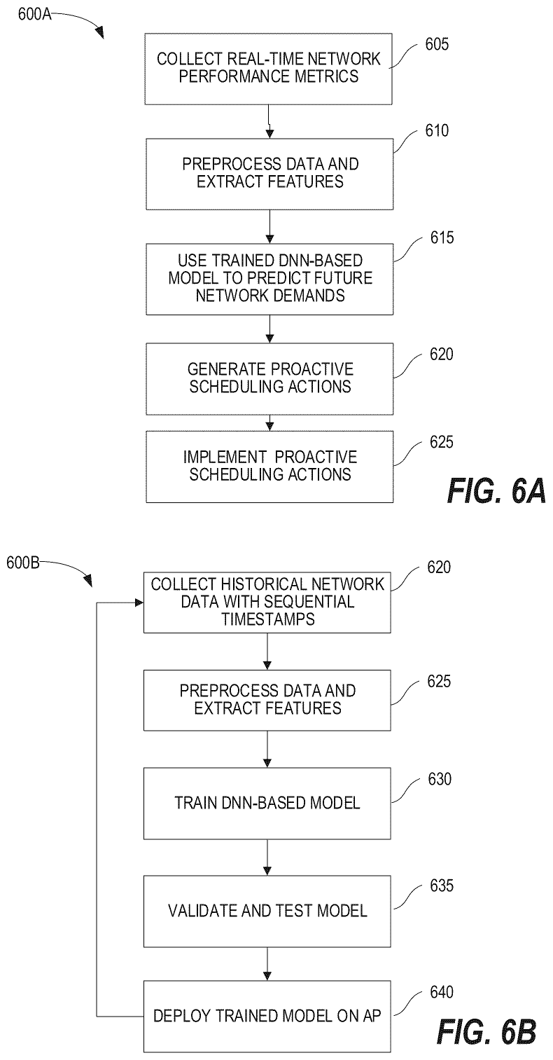

FIGS. 6A and 6B depict example methods for DNN-based model training and real-time inference for predictive scheduling, according to some embodiments of the present disclosure. More specifically, the example method 600A in FIG. 6A focuses on the inference process for predicting network demand and implementing proactive scheduling actions in real time, and the example method 600B in FIG. 6B addresses the training process for the DNN-based model. The example methods 600A and 600B may be implemented by an AP, such as the AP 105 as depicted in FIGS. 1A and 1B or the AP 505 as depicted in FIG. 5, or any other wireless devices that manage network resource and/or provide link adaptation capabilities.

At block 605, an AP (e.g., 105 of FIGS. 1A and 1B, or 505 of FIG. 5) collects real-time input data (e.g., 250 of FIG. 2) for model inference. In some embodiments, the real-time input data may include network-wide data monitored by the AP monitors internally and/or client-specific data reported by connected STA. In some embodiments, the data may include parameters that reflect the current state of the network, such as throughput, latency, channel utilization, RSSI, the number of active device, error rates, as well as parameters that reflect temporal context, such as timestamps (e.g., 2:00 PM) or time-of-day indicators (e.g., morning, lunch hour).

At block 610, the input data is preprocessed to ensure it is clean and ready for input into the ML model. In some embodiments, the preprocessing may include data cleaning, normalization, and feature extraction. The raw data may first be cleaned to remove inaccuracies and inconsistencies. Once clean, the data may be normalized to ensure all features are on the same scale. After that, the data may be analyzed to identify the relevant input features for model prediction. In some embodiments, these input features may include metrics reflecting network performance (e.g., throughput, latency, and channel utilization), metrics reflecting device behavior (e.g., device activity level, signal strength), and temporal features (e.g., timestamps, time-of-day indicators).

At block 615, the preprocessed input data is provided into a trained DNN-based model (e.g., 240 of FIG. 2), which includes LSTM layers to handle sequential data. The model analyzes the input features to predict future network demand (e.g., 265 of FIG. 2) over a defined time interval. In some embodiments, the prediction may include expected throughput, latency, and channel utilization, and the estimated number of active devices, among others. More details about the DNN-based model training are discussed below with reference to FIG. 6B.

At block 620, based on the predicted output, the AP generates proactive scheduling actions (e.g., 280 of FIG. 2) to optimize network performance. In some embodiments, these actions may include mode switching (e.g., deciding whether to switch between OFDMA and MU-MIMO), reassigning RUs in OFDMA, or reconfiguration user groupings in MU-MIMO to meet predicted demands.

At block 625, once the scheduling actions are determined, the AP implements these decisions by updating its internal configurations. In embodiments where the actions require changes at the STA (e.g., altering MCS level or frame aggregation settings), the AP may communicate the necessary adjustments to the STA using management frames. In some embodiments, the communication may be facilitated through lightweight communication protocols (as depicted in FIG. 5) to minimize (or at least reduce) overhead and maintain seamless synchronization between the AP and STAs.

FIG. 6B provides an overview of the training process for the DNN-based model before deployment. As depicted, the training process begins at block 620, where historical network performance data is collected for model training. The training dataset (e.g., 205 of FIG. 2) may include sequentially timestamped records of various metrics, such as throughput, latency, channel utilization, RSSI, the number of active devices, and other parameters. Temporal information, such as timestamps or time-of-day indicators, may also be included to capture the recurring patterns in network behavior (e.g., increased demand during peak hours).

At block 625, the training dataset is preprocessed to prepare it for training. In some embodiments, the preprocessing (e.g., 210 of FIG. 2) may include cleaning the raw data, normalizing it for uniform scaling, and extracting relevant features for both input and output. In some embodiments, the input features (e.g., 220 of FIG. 2) represent the current state of the network and device behavior and may include network performance metrics (e.g., throughput, latency, and channel utilization), device behavior metrics (e.g., device activity level, signal strength) and temporal features (e.g., timestamps, time-of-day indicators). In some embodiments, the target output features (e.g., 230 of FIG. 2) represent the state or network demand in a future time interval. These output metrics provide the ground truth for the model to learn from and may include measured throughput, latency, device activity levels, and channel utilization.

At block 630, the preprocessed training dataset is used to train the DNN-based model with LSTM layers (e.g., 240 of FIG. 2). During the training process, the model predicts future network demand based on the input features. The predicted outputs are then compared to the target outputs (e.g., measured throughput) using a loss function (e.g., mean squared error (MSE). Using BPTT techniques, the loss is propagated backward through the network layers, updating each parameter (e.g., weights or biases) via optimization algorithms (e.g., SGD). Over multiple such training epochs, the model gradually learns to predict accurately by refining its internal parameters.

After the training is completed, at block 635, the model is validated and tested to ensure its accuracy when applied to unseen data. The validation process is conducted to identify and mitigate overfitting issues, where the model performs well on the training dataset but fails to generalize to new data. Metrics such as validation loss may be monitored during this process and adjustments may be made to improve the model's performance (e.g., tuning hyperparameters or applying regularization techniques). In some embodiments, after validation is completed but before deployment, the mode is tested using a testing dataset. The dataset may be separate from both the training and validation datasets to provide an independent assessment of the model's performance.

Once the model's performance meets predefined performance criteria (e.g., achieving acceptable levels of prediction accuracy or mean squared error falling below a threshold), it is deployed on the AP (e.g., as part of the ML-based predictive scheduling module 260 of FIG. 2). During inference (as depicted in FIG. 6A), the model processes real-time data to predict network demand. These predictions then guide the determination of proactive scheduling actions (e.g., 280 of FIG. 2) for more efficient resource utilization.

In some embodiments, the AP may continue to collect real-time network performance data during operation, including metrics such as measured throughput, latency, channel utilization, and the detected number of active devices. The newly collected data may be periodically added to the training dataset (e.g., 205 of FIG. 2), and the model (e.g., 240 of FIG. 2) may be retrained with the expanded dataset using incremental learning techniques-techniques that update the model's parameters without requiring full retraining from scratch. This approach allows the model to adapt to evolving network conditions, such as changes in device behavior, environmental factors, or traffic patterns.

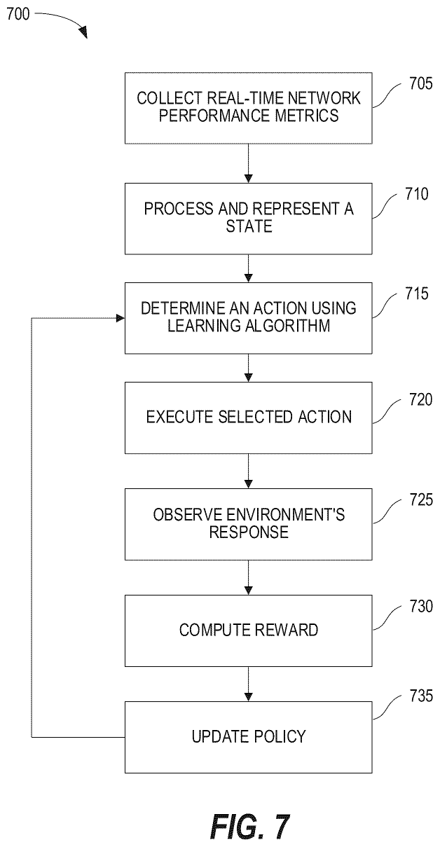

FIG. 7 depicts an example method 700 for adaptive resource management using reinforcement learning, according to some embodiments of the present disclosure. The example method 700 may be implemented by an AP, such as the AP 105 as depicted in FIGS. 1A and 1B or the AP 505 as depicted in FIG. 5, or any other wireless devices that manage network resource and/or provide link adaptation capabilities.

At block 705, an AP implements an RL framework using a learning algorithm (e.g., 310 of FIG. 3), such as Q-learning or DQN. The AP collects real-time network metrics that reflect the current state of the network, including but not limited to, throughput, latency, RSSI, channel utilization, and the number of active devices. These metrics serve as the foundation for defining the state of the environment (Sₜ) (e.g., 320 of FIG. 3) in the RL process.

At block 710, the collected network metrics are processed and transformed into a structure representation of the current state (Sₜ) (e.g., 320 of FIG. 3) of the environment.

At block 715, the current state (Sₜ) is fed into the RL agent (e.g., DQN algorithm), which evaluates the available actions (e.g., 330 of FIG. 3) based on Q-value associated with each action. As used herein, Q-value represents the expected rewards of taking specific actions in the current state. The RL agent selects the action with the highest Q-value, which is expected to yield the most favorable outcome for network performance. The possible actions may include switching mode between OFDMA and MU-MIMO, adjusting the number and size of RUs assigned to devices in OFDMA, reconfiguring user groupings to optimize spatial stream usage in MU-MIMO, and others.

At block 720, the RL agent executes the selected action (Aₜ) in the environment. This may include the AP configuring its internal settings directly to implement the change, such as switching to MU-MIMO for high-throughput applications, reallocating RUs, or adjusting spatial stream groupings. In embodiments where the selected action requires adjustment from connected STAs, the AP may communicate the necessary information to the STAs (e.g., using management frames) for synchronized implementation of the selected action.

At block 725, after executing the action, the RL agent observes the environment response, which is represented as the new state (Sₜ₊₁). The response includes updated network metrics, such as changes in throughput, latency, or channel utilization, which reflect the impact of the executed action.

At block 730, a reward (e.g., 325 of FIG. 3) is calculated based on the environment's response to the executed action. As used herein, the reward quantifies the effectiveness of the action and guides the RL agent in improving its decision-making process. In some embodiments, the reward may be determined based on metrics like throughput (or goodput), latency, or user satisfaction scores. For example, a positive reward may be assigned if an action leads to increased throughput, reduced latency, and improved user satisfaction scores. In contrast, a negative reward may be assigned if an action leads to decreased throughput, increased latency, and decreased user satisfaction scores. Additionally, a neutral reward may be defined if no significant change occurs.

At block 735, using the computed reward and the new state, the RL agent updates its policy to improve the accuracy for future decision-making. The RL agent adjusts the Q-values for the state-action pairs, reinforcing actions that lead to positive rewards while penalizing actions that result in negative rewards. The method 700 then returns to block 715, where a new action is selected based on the new state and updated Q-values. The iterative learning process enables the RL agent to refine its policy over time and optimize the model's ability to select actions that improve network performance under varying conditions.

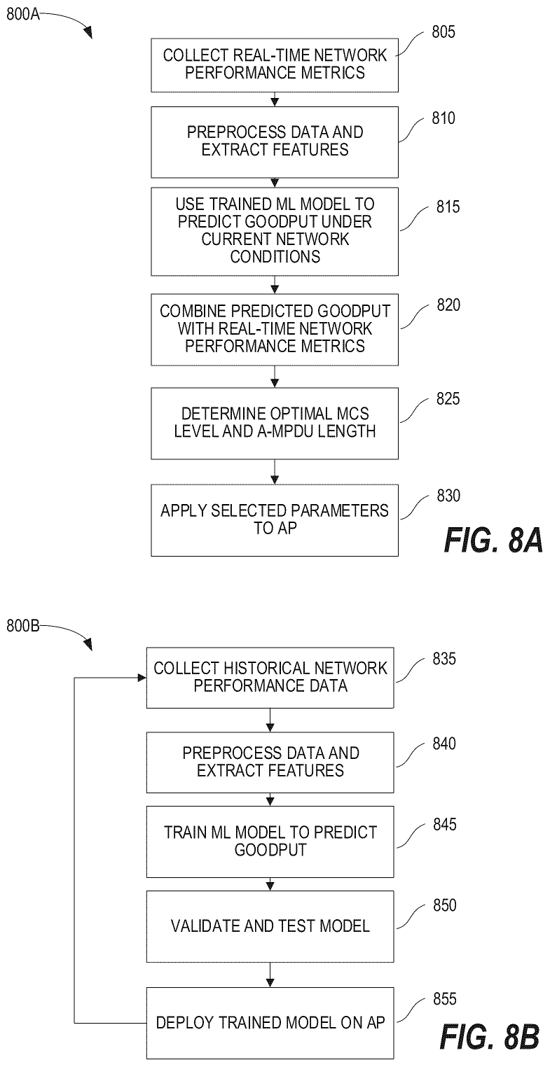

FIGS. 8A and 8B depict example methods for AI-driven link adaptation, including model training, real-time inference for goodput prediction, and determination of link configuration parameters, according to some embodiments of the present disclosure. Specifically, the example method 800A as depicted in FIG. 8A focuses on the inference process for determining optimal link parameters based on predicted goodput, and the example method 800B of FIG. 8B details the training process for the ML model used in this framework. The example methods 800A and 800B may be implemented by an AP, such as the AP 105 as depicted in FIGS. 1A and 1B or the AP 505 as depicted in FIG. 5, or any other wireless devices that manage network resource and/or provide link adaptation capabilities.

At block 805, an AP (e.g., 105 of FIGS. 1A and 1B, 505 of FIG. 5) collects real-time input data (e.g., 450 of FIG. 5) that reflect current network conditions. The data may include network-wide data monitored by the AP internally (e.g., channel utilization, BW, MCS, the number of active devices, the number of spatial streams) and client-specific data (e.g., RSSI, LTF power, pilot EVM, clock frequency offset, timing offset) reported by individual STAs (e.g., 110 of FIGS. 1A and 1B, 510 of FIG. 5).

At block 810, the collected data is preprocessed to maintain consistency, making the data ready for model inference. In some embodiments, the preprocessing may include cleaning the raw data to filter out invalid or corrupted values, normalizing the data to ensure for uniform scaling, and processing the data to identify relevant input features for model prediction. In some embodiments, the features extracted from the input data may represent the current network condition, including RSSI, MCS level, BW, and the NSS.

At block 815, the preprocessed data is provided as input into the trained ML model, which predicts goodput (e.g., 465 of FIG. 4) under the current network conditions. The predicted goodput indicates the achievable throughput estimated by the ML model, accounting for the effects of current signal quality, channel utilization, and device-specific behavior. The predicted goodput eliminates the need for measuring actual goodput after testing or experimentation (typically used in conventional trail-and-error methods). More details about the model training process are discussed below with reference to FIG. 8B.

At block 820, the predicted goodput is combined with the real-time input data to form an aggregated dataset for decision-making. At block 825, the AP use the combined data to determine the optimal (or at least improved) link configuration, including the optimal MCS level and A-MPDU length that maximize (or at least improve) throughput without increasing retransmissions or latency.

At block 830, the determined link parameters (e.g., MCS level, A-MPDU length) are applied by the AP to the network. For AP-side adjustments, such as increasing/decreasing the A-MPDU length, the AP may independently configure its radio firmware to implement the updated link settings without requiring STA involvement. For adjustments that require synchronization between the AP (e.g., 505 of FIG. 5) and the STAs (e.g., 510 of FIG. 5), such as modifying MCS level for encoding and decoding data, the AP may not only update its own settings but also communicate the necessary information to the STA, to ensure both ends using the same link configuration. The exchange of such information may be carried via management frames using lightweight communication protocols.

FIG. 8B provides an overview of training the ML model for goodput prediction. At block 835, the historical network performance data (e.g., 405 of FIG. 4) is collected for model training. In some embodiments, the training dataset may include various metrics that reflect network conditions, such as RSSI, BW, channel utilization, the MCS level, and the NSS, as well as the corresponding measured goodput at the application layer of a receiving device.

At block 840, the raw historical data is preprocessed to prepare it for training. This may include data cleaning (e.g., removing invalid or corrupted data), data normalization (e.g., scaling data to a uniform range), and feature extraction (e.g., identifying relevant input and output features). In some embodiments, the metrics that reflect network conditions may be identified as input features (e.g., 420 of FIG. 4), and the measured goodput under varying conditions may be identified as the corresponding target output feature (e.g., 430 of FIG. 4). In some embodiments, computed metrics that capture trends or temporal variations in network conditions may also be included as additional input features. These may include the average of RSSI or SNR over recent intervals or moving average of MCS changes over time.

At block 845, the model is trained using the preprocessed training dataset. In some embodiments, the model (e.g., 440 of FIG. 4) may be implemented using algorithms such as GBM or DNNs. During training, the model first generates a predicted goodput based on the received input features. The predicted output is then compared to the target goodput using a loss function to determine an error. With the determined error, backpropagation is applied backward through the model layers to update the model's parameters (e.g., weights or biases) using optimization algorithm (e.g., SGD). Over multiple training epochs, the model refines its predictions with improved accuracy.

Once training is complete, at block 850, the model is validated and tested before deployment. In some embodiments, a validation dataset, separate from the training dataset, may be used to test the model's accuracy on unseen data and refine the model (e.g., adjusting hyperparameters) to avoid overfitting on the training dataset. In some embodiments, a testing dataset may be applied to the model after validation is complete to confirm the model's readiness for deployment (e.g., meeting predefined performance criteria).

At block 855, the trained ML is deployed to the AP as part of the ML-based link adaptation module (e.g., 460 of FIG. 4). Once deployed, the model operates in real time, analyzing input network data (as depicted in FIG. 8A) to predict goodput and guide link parameter adjustments.

In some embodiments, the AP may continue to collect goodput data generated during real-time operation and integrate the data into the training dataset. The expanded training dataset may then be used periodically to retrain the model using incremental learning techniques. These techniques update the model's parameters without requiring full training from scratch, and therefor reduce computational overhead and provide faster adaptation.

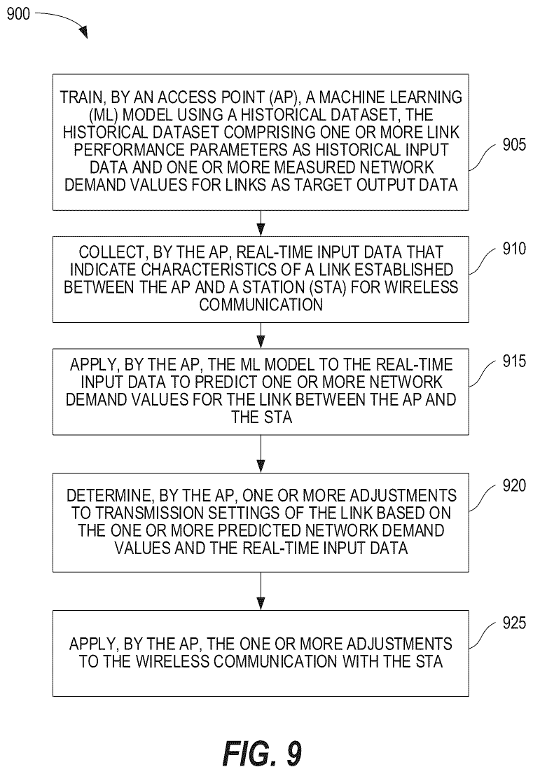

FIG. 9 is a flow diagram depicting an example method 900 for AI-driven link adaptation and resource management, according to some embodiments of the present disclosure.

At block 905, an AP (e.g., 105 of FIGS. 1A and 1B, 505 of FIG. 5) trains a ML model (e.g., 240 of FIG. 2, 310 of FIG. 3, 440 of FIG. 4) using a historical dataset (e.g., 205 of FIG. 2, 405 of FIG. 4), the historical dataset comprising one or more link performance parameters as historical input data (e.g., 220 of FIG. 2, 420 of FIG. 4) and one or more measured network demand values for links as target output data (e.g., 230 of FIG. 2, 430 of FIG. 4).

At block 910, the AP collects real-time input data (e.g., 250 of FIG. 2, 320 of FIG. 3, 450 of FIG. 4) that indicate characteristics of a link established between the AP and a station (STA) (e.g., 110 of FIGS. 1A and 1B, 510 of FIG. 5) for wireless communication.

At block 915, the AP applies the ML model to the real-time input data to predict one or more network demand values for the link between the AP and the STA (e.g., 265 of FIG. 2, 465 of FIG. 4).

At block 920, the AP determines one or more adjustments to transmission settings of the link (e.g., 280 of FIG. 2, 330 of FIG. 3, 480 of FIG. 4) based on the one or more predicted network demand values and the real-time input data.

At block 925, the AP applies the one or more adjustments to the wireless communication with the STA (e.g., switching mode between OFDMA and MU-MIMO, reallocating RUs, reconfiguring user groupings).

In some embodiments, the real-time input data may comprise at least one of one or more client-specific link performance parameters received from the STA, or one or more network-wide link performance parameters observed by the AP, and the one or more client-specific link performance parameters (e.g., 525 of FIG. 5) may be sent by the STA to the AP using a lightweight communication protocol with reduced payload overhead.

In some embodiments, the AP may further communicate the one or more adjustments (e.g., 535 of FIG. 5) to the STA using a lightweight communication protocol with reduced payload overhead.

In some embodiments, the one or more adjustments to transmission settings may comprise at least one of adjusting a modulation and coding scheme (MCS) index or changing an aggregated medium access control protocol data unit (A-MPDU).

In some embodiments, the one or more predicted network demand values may comprise a goodput value (e.g., 465 of FIG. 4) that represents an amount of actual data successfully delivered to an application layer of the STA via the link.

In some embodiments, the process of training the ML model using the historical dataset may comprise applying a neural network algorithm comprising one or more layers of interconnected nodes, generating a predicted goodput value based on processing the historical input data, determining a difference between the predicted goodput value and a corresponding measured goodput value from the historical dataset, performing backpropagation to reduce the difference by adjusting one or more weights or biases of the interconnected nodes, and outputting the neural network algorithm with the adjusted weights or biases as the trained ML model.

In some embodiments, the STA may comprise a reasoning system configured to analyze the real-time input data to identify one or more link performance parameters (e.g., 525 of FIG. 5) associated with the link between the AP and the STA, and generate a recommendation (e.g., 530 of FIG. 5) for adjusting the transmission settings of the link based on one or more performance requirements of the STA.

In some embodiments, the one or more performance requirements of the STA may comprise at least one of preserving battery, stabilizing signal, maximizing throughput, and minimizing latency.

In some embodiments, the process of determining the one or more adjustments to the transmission settings of the link may comprise receiving, by the AP, the one or more client-specific recommendations from the STA, and determining, by the AP, the one or more adjustments to the one or more transmission settings, where the determination considers: the one or more network demand values, one or more network-wide link performance parameters received from the STA, one or more client-specific link performance parameters observed by the AP, and the one or more client-specific recommendation received from the STA.

In some embodiments, the AP may further determine one or more actions for improving a performance of the link between the AP and the STA, the one or more actions comprising at least one of switching between multiple-input multiple-output (MIMO) and orthogonal frequency-division multiple access (OFDMA) modes, reallocating one or more spatial streams to the STA, and reallocating one or more resource units (RUs) to the STA.

In some embodiments, the historical dataset may further comprise sequential timestamps, and the one or more link performance parameters and corresponding sequential timestamps may be aggregated as the historical input data (e.g., 220 of FIG. 2).

In some embodiments, the process of training the ML model using the historical dataset may comprise applying a neural network algorithm comprising one or more layers of interconnected nodes, where the one or more layers comprises a long short-term memory (LSTM) layer, processing the historical dataset (e.g., 205 of FIG. 2) to identify temporal dependencies between the sequential timestamps and the one or more link performance parameters, generating a predicted network demand value for a future time interval, wherein the predicted network demand value comprises at least one of a throughput value, a latency value, or a number of active devices, determining a difference between the predicted network demand value and a corresponding measured network demand value from the historical dataset, performing backpropagation to reduce the difference by adjusting one or more weights or biases of the interconnected nodes, and outputting the neural network algorithm with the adjusted weights or biases as the trained ML model.

In some embodiments, the process of training the ML model using the historical dataset may comprise applying, by the AP, a reinforcement learning (RL) framework, the RL framework comprising a state space (e.g., 320 of FIG. 3), comprising one or more link performance parameters within the real-time input data, an action space (e.g., 330 of FIG. 3), comprising the one or more adjustments to transmission settings, and a reward function (e.g., 325 of FIG. 3) configured based on a defined policy, training, by the AP, the RL framework through interactions with a wireless network comprising the AP and the STA, where the RL framework observes the state space, selects an action, and receives a reward based on observed network performance, and updating, by the AP, the RL framework through iterative learning, using Q-learning to increase cumulative rewards over time.

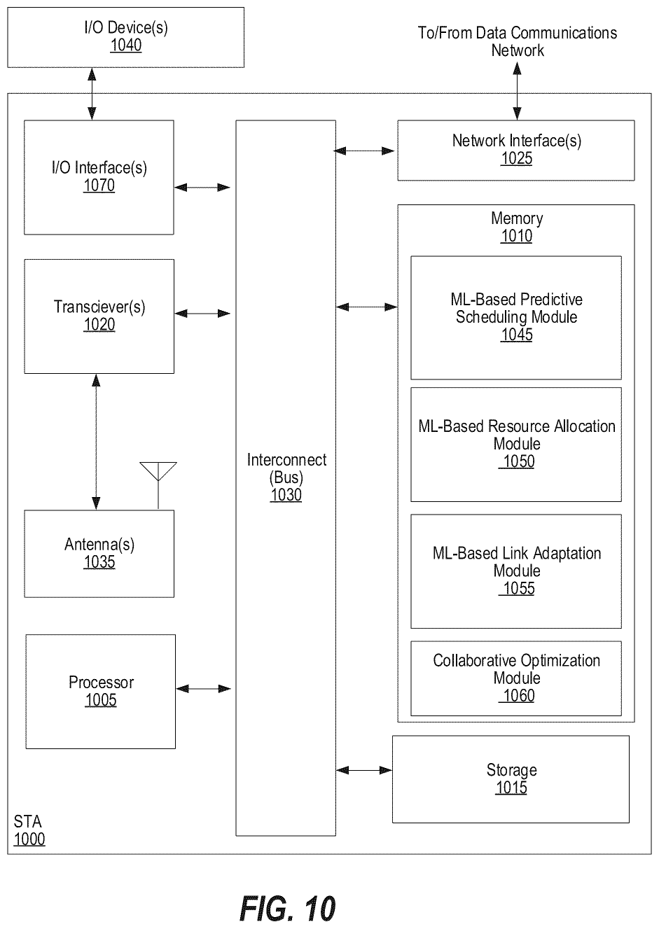

FIG. 10 depicts an example network device 1000 configured to perform various aspects of the present disclosure, according to some aspects of the present disclosure. In some embodiments, the network device 1000 may correspond to an AP, such as the AP 105 as depicted in FIGS. 1A and 1B, or the AP 505 as depicted in FIG. 5. In some embodiments, the network device 1000 may correspond to a WLC or any other network device capable of managing network resource and/or providing link adaptation capabilities.

As illustrated, the example network device 1000 includes a processor 1005, memory 1010, storage 1015, one or more transceivers 1020, one or more I/O interfaces 1080, and one or more network interfaces 1025. In some embodiments, I/O devices 1040 are connected via the I/O interface(s) 1080. Further, via the network interface 1025, the network device 1000 can be communicatively coupled with one or more other devices and components (e.g., via a network, which may include the Internet, local network(s), and the like). Each of the components is communicatively coupled by one or more buses 1030. In some embodiments, one or more antennas 1035 may be coupled to the transceivers 1020 for transmitting and receiving wireless signals.

The processor 1005 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1005 processes information received through the transceiver 1020, I/O interfaces 1080, and the network interfaces 1025. The processor 1005 retrieves and executes programming instructions stored in memory 1010, as well as stores and retrieves application data residing in storage 1015.

The storage 1015 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1015 may store a variety of data for the efficient functioning of the system.

The memory 1010 may include random access memory (RAM) and read-only memory (ROM). The memory 1010 may store processor-executable software code containing instructions that, when executed by the processor 1005, enable the network device 1000 to perform various functions described herein for wireless communication. In the illustrated example, the memory 1010 includes four software modules: the ML-based predictive scheduling module 1045, the ML-based resource allocation module 1050, the ML-based link adaptation module 1055, and collaborative optimization component 1060.

In some embodiments, the ML-based predictive scheduling module 1045 may correspond to the module 260 as depicted in FIG. 2. The ML-based predictive scheduling module 1045 implements the trained ML model (e.g., 240 as depicted in FIG. 2) for network optimization. Specifically, in some embodiments, the ML-based predictive scheduling module 1045 may utilize real-time input data (e.g., 250 of FIG. 2) and historical patterns to predict network demand (e.g., throughput, latency, and device activity) over future time intervals. Based on the predictions (e.g., 265 of FIG. 2), the module 1045 may generate proactive scheduling actions (e.g., 280 of FIG. 2), such as mode switching, resource allocation adjustments, or prioritization of specific applications. These actions are designed to optimize network performance before high-demand conditions occur.

In some embodiments, the ML-based resource allocation module 1050 may correspond to the module 305 as depicted in FIG. 3. The ML-based resource allocation module 1050 may implement a RL framework for network optimization. With the RL agent, the ML-based resource allocation module 1050 may evaluate the current network state (Sₜ) (e.g., 320 of FIG. 3), select optimal actions (e.g., mode switching, RU adjustments, or user group reconfiguration) (e.g., 330 of FIG. 3), and execute the selected actions in the environment (e.g., 315 of FIG. 3). The RL agent may then refine its decision-making policy over time by observing the environment's response to actions (represented as the new state) and updating the policy based on reward signals.

In some embodiments, the ML-based link adaptation module 1055 may correspond to the module 460 as depicted in FIG. 4. The ML-based link adaptation module 1055 implements the trained ML model (e.g., 440 of FIG. 4) for network optimization. Specifically, using real-time input data, the ML-based link adaptation module 1055 may predict the achievable goodput under current network conditions. Based on the predicted goodput, the module 1055 may determine optimal link parameters, such as MCS level and A-MPDU lengths, that maximize (or at least improve) throughput without compromising reliability.

In some embodiments, the collaborative optimization module 1060 may implement the decision-making mechanism as described in FIG. 5, which enables the AP to balance STA-specific preference with network-wide goals. Specifically, in some embodiments, the collaborative optimization module 1060 may collect real-time performance metrics (e.g., 525 of FIG. 5) and configuration preferences (e.g., 530 of FIG. 5) from connected STAs using lightweight communication protocols. The module 1060 may evaluate the combined input from STAs and network-side metrics, and determine actions (e.g., mode switching, resource assignment, or fine-grained link adjustments) that align with overall network performance goals while accommodating individual STA's preferences.

The four software modules are provided for conceptual clarity. In some embodiments, the network device 1000 may include any one or a combination of the four modules to support link adaptation and resource management based on the network's specific requirements and capabilities. For example, in some embodiments, the network device may implement the ML-based predictive scheduling module 1045 and the ML-based link adaptation module 1055 to enable proactive network-level adjustments while maintaining optimal link parameters for individual devices. In some embodiments, the network device may include the ML-based resource allocation module 1050 for dynamic, real-time resource management along with the ML-based link adaptation module 1055 for fine-grained link parameter tuning. In some embodiments, the network devices may further implement the collaborative optimization module 1060 with the ML-based predictive scheduling module 1045, the ML-based resource allocation module 1050, and/or the ML-based link adaptation module 1055 to balance STA-specific preferences with network-wide goals and improve communication efficiency.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
training, by an access point (AP), a machine learning (ML) model using a historical dataset, the historical dataset comprising one or more link performance parameters as historical input data and one or more measured network demand values for links as target output data;
collecting, by the AP, real-time input data that indicate characteristics of a link established between the AP and a station (STA) for wireless communication;
applying, by the AP, the ML model to the real-time input data to predict one or more network demand values for the link between the AP and the STA;
determining, by the AP, one or more adjustments to transmission settings of the link based on the one or more predicted network demand values and the real-time input data; and
applying, by the AP, the one or more adjustments to the wireless communication with the STA.

2. The method of claim 1, wherein the real-time input data comprises at least one of one or more client-specific link performance parameters received from the STA, or one or more network-wide link performance parameters observed by the AP, and wherein the one or more client-specific link performance parameters are sent by the STA to the AP using a lightweight communication protocol with reduced payload overhead.

3. The method of claim 1, further comprising communicating, by the AP, the one or more adjustments to the STA using a lightweight communication protocol with reduced payload overhead.

4. The method of claim 1, wherein the one or more adjustments to transmission settings comprises at least one of adjusting a modulation and coding scheme (MCS) index or changing an aggregated medium access control protocol data unit (A-MPDU).

5. The method of claim 1, wherein the one or more predicted network demand values comprises a goodput value that represents an amount of actual data successfully delivered to an application layer of the STA via the link.

6. The method of claim 5, wherein training the ML model using the historical dataset comprises:
applying a neural network algorithm comprising one or more layers of interconnected nodes;
generating a predicted goodput value based on processing the historical input data;
determining a difference between the predicted goodput value and a corresponding measured goodput value from the historical dataset;
performing backpropagation to reduce the difference by adjusting one or more weights or biases of the interconnected nodes; and
outputting the neural network algorithm with the adjusted weights or biases as the trained ML model.

7. The method of claim 1, wherein the STA comprises a reasoning system configured to:
analyze the real-time input data to identify one or more link performance parameters associated with the link between the AP and the STA; and
generate one or more client-specific recommendations for adjusting the transmission settings of the link based on one or more performance requirements of the STA.

8. The method of claim 7, wherein the one or more performance requirements of the STA comprises at least one of preserving battery, stabilizing signal, maximizing throughput, and minimizing latency.

9. The method of claim 7, wherein determining the one or more adjustments to the transmission settings of the link comprises:
receiving, by the AP, the one or more client-specific recommendations from the STA; and
determining, by the AP, the one or more adjustments to the transmission settings, wherein the determination considers:
the one or more network demand values,
one or more network-wide link performance parameters received from the STA,
one or more client-specific link performance parameters observed by the AP, and
the one or more client-specific recommendation received from the STA.

10. The method of claim 1, further comprising determining, by the AP, one or more actions for improving a performance of the link between the AP and the STA, the one or more actions comprising at least one of switching between multiple-input multiple-output (MIMO) and orthogonal frequency-division multiple access (OFDMA) modes, reallocating one or more spatial streams to the STA, and reallocating one or more resource units (RUs) to the STA.

11. The method of claim 1, wherein the historical dataset further comprises sequential timestamps, and the one or more link performance parameters and corresponding sequential timestamps are aggregated as the historical input data.

12. The method of claim 11, wherein training the ML model using the historical dataset comprises:
applying a neural network algorithm comprising one or more layers of interconnected nodes, wherein the one or more layers comprises a long short-term memory (LSTM) layer;
processing the historical dataset to identify temporal dependencies between the sequential timestamps and the one or more link performance parameters;
generating a predicted network demand value for a future time interval, wherein the predicted network demand value comprises at least one of a throughput value, a latency value, or a number of active devices;
determining a difference between the predicted network demand value and a corresponding measured network demand value from the historical dataset;
performing backpropagation to reduce the difference by adjusting one or more weights or biases of the interconnected nodes; and
outputting the neural network algorithm with the adjusted weights or biases as the trained ML model.

13. The method of claim 1, wherein training the ML model using the historical dataset comprises:
applying, by the AP, a reinforcement learning (RL) framework, the RL framework comprising:
a state space, comprising the one or more link performance parameters within the historical dataset,
an action space, comprising the one or more adjustments to transmission settings, and
a reward function configured based on a defined policy;
training, by the AP, the RL framework through interactions with a wireless network comprising the AP and the STA, wherein the RL framework observes the state space, selects an action, and receives a reward based on observed network performance; and
updating, by the AP, the RL framework through iterative learning, using Q-learning to increase cumulative rewards over time.

14. A system, comprising:
one or more memories collectively containing one or more programs; and
one or more processors, wherein the one or more processors are configured to, individually or collectively, perform an operation comprising:
training, by an access point (AP), a machine learning (ML) model using a historical dataset, the historical dataset comprising one or more link performance parameters as historical input data and one or more measured network demand values for links as target output data;
collecting, by the AP, real-time input data that indicate characteristics of a link established between the AP and a station (STA) for wireless communication;
applying, by the AP, the ML model to the real-time input data to predict one or more network demand values for the link between the AP and the STA;
determining, by the AP, one or more adjustments to transmission settings of the link based on the one or more predicted network demand values and the real-time input data; and
applying, by the AP, the one or more adjustments to the wireless communication with the STA.

15. The system of claim 14, wherein the real-time input data comprises at least one of one or more client-specific link performance parameters received from the STA, or one or more network-wide link performance parameters observed by the AP, and wherein the one or more client-specific link performance parameters are sent by the STA to the AP using a lightweight communication protocol with reduced payload overhead.

16. The system of claim 14, wherein the operation further comprises communicating, by the AP, the one or more adjustments to the STA using a lightweight communication protocol with reduced payload overhead.

17. The system of claim 15, wherein the one or more adjustments to transmission settings comprises at least one of adjusting a modulation and coding scheme (MCS) index or changing an aggregated medium access control protocol data unit (A-MPDU).

18. The system of claim 15, wherein the one or more predicted network demand values comprises a goodput value that represents an amount of actual data successfully delivered to an application layer of the STA via the link.

19. The system of claim 18, wherein training the ML model using the historical dataset comprises:
applying a neural network algorithm comprising one or more layers of interconnected nodes;
generating a predicted goodput value based on processing the historical input data within the historical dataset;
determining a difference between the predicted goodput value and a corresponding measured goodput value from the historical dataset;
performing backpropagation to reduce the difference by adjusting one or more weights or biases of the interconnected nodes; and
outputting the neural network algorithm with the adjusted weights or biases as the trained ML model.

20. One or more computer-readable media containing, in any combination, computer program code that, when executed by a computer system, performs an operation comprising:
training, by an access point (AP), a machine learning (ML) model using a historical dataset, the historical dataset comprising one or more link performance parameters as historical input data and one or more measured network demand values for links as target output data;
collecting, by the AP, real-time input data that indicate characteristics of a link established between the AP and a station (STA) for wireless communication;
applying, by the AP, the ML model to the real-time input data to predict one or more network demand values for the link between the AP and the STA;
determining, by the AP, one or more adjustments to transmission settings of the link based on the one or more predicted network demand values and the real-time input data; and
applying, by the AP, the one or more adjustments to the wireless communication with the STA.
